(19) United States
(12) Patent Application Publication
(10) Pub. No.: US 2013/0016037 A1
(43) Pub. Date: Jan. 17, 2013

(54) REDUCING OR ELIMINATING THE BLACK MASK IN AN OPTICAL STACK

(71) Applicant: Hung-Jen Wang, Longtan Township (TW)

(72) Inventor: Hung-Jen Wang, Longtan Township (TW)

(73) Assignee: QUALCOMM MEMS TECHNOLOGIES, INC., San Diego, CA (US)

(21) Appl. No.: 13/180,394

(22) Filed: Jul. 11, 2011

(51) Int. Cl. G06T 1/00; B32B 37/14; B32B 37/02; G06F 3/01; G02B 26/00

(52) U.S. Cl. 345/156; 345/501; 359/291; 156/292

(57) ABSTRACT

A reflective subpixel array may be formed in which an absorption layer is formed on a back substrate, which may obviate the need for a black mask on a front substrate upon which the reflective subpixel array is formed. In some implementations, the black mask layer may be formed only in post areas on the front substrate. The absorption layer may absorb light that enters between subpixel rows and/or columns. The absorption layer may include at least one highly conductive layer that can form part of the signal routing for the display. Conductive spacers may be formed to connect the conductive absorption layer to a conductive layer of the subpixel array.

### TECHNICAL FIELD

This disclosure relates to display devices, including but not limited to display devices that incorporate electromechanical systems.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

A black mask layer can provide various functions for reflective displays. One function of a black mask is to block light from selected areas of a display. For example, in certain applications, it may not desirable to have light reflecting from a post or other support structures. A black mask may be formed of multiple layers having thicknesses selected for destructive interference of incident visible light. Therefore, black mask material may be formed in post areas and in other inactive portions of the display. In some displays, black mask material may also form part of the circuitry of a subpixel array.

The percentage of the active area, as compared to the total area, of the display is sometimes referred to as the “fill factor.” From a fill factor viewpoint, the areas of the display covered by the black mask may be considered parasitic, because these areas reduce the overall brightness of the reflected light. Moreover, gaps in the black mask can create topology in the subpixel array. This topology can result in additional stiction of an IMOD's movable or “mechanical” layer.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus in which a black mask is formed on a back substrate or backplate of a display device rather than at inter-post columns within pixels or sub-pixels of the display device. While some implementations of a display device include inter-post columns of black mask material to mask the entry of light through gaps in the pixels or sub-pixels, removing the black mask columns may allow light to enter areas of the display that were previously covered by the black mask material. An absorption layer may be formed on the back substrate or backplate of the apparatus in order to prevent this light from reflecting back through the array glass.

In alternative implementations, the black mask layer may only be formed in post areas of an array to form isolated portions of black mask rather than continuous rows of conductive material. In such implementations, the absorption layer formed on the back substrate may be conductive and can form part of the signal routing for the display. Alternatively, a conductive layer may be formed on top of the absorption layer. Conductive spacers may be formed to connect the conductive absorption layer or the overlying conductive layer to a conductive portion of the stationary layer (referred to herein as the “M1 layer”). Accordingly, the row electrodes of the subpixel array may include the M1 layer and the conductive absorption layer or the overlying conductive layer. The conductive absorption layer or the overlying conductive layer may be formed into electrically isolated rows.

In still other implementations, there may be no black mask layer formed between the M1 layer and a first side of the array glass. The M1 layer and electrically isolated rows of the conductive absorption layer or the overlying conductive layer may be electrically connected by the conductive spacers. In some such implementations, black mask material (or a similar material) may be formed in the post areas on a second side of the array glass, to prevent light from reflecting from posts in the subpixel array.

Some implementations described herein provide an apparatus that includes a substantially transparent first substrate, an array of interferometric modulation subpixels disposed on the substantially transparent substrate, and a second substrate attached to the first substrate and configured to form an enclosure for the array of interferometric modulation subpixels. The apparatus may include an absorption layer formed on the second substrate. The absorption layer may be configured to absorb light that enters the substantially transparent first substrate and passes between gaps in the array of interferometric modulation subpixels.

The subpixels may include a mechanical reflective layer formed into column electrodes and a partially reflective layer formed into row electrodes. The column electrodes and the row electrodes may be patterned to form the gaps. The absorption layer may be configured for electrical communication with the interferometric modulation subpixels. The apparatus may include conductive spacers configured for providing electrical communication between the absorption layer and the interferometric subpixels.

The apparatus may include a plurality of posts configured to support edges of the mechanical reflective layer and black mask material formed in some areas of some of the posts. The black mask material may be configured for electrical communication with the partially reflective layer and forms part of the row electrodes. The black mask material may be formed only in the areas of the posts. Alternatively, the black mask material may be formed in the areas of the posts and in row areas between the posts. The black mask material may be formed between the first substrate and the partially reflective layer.

The absorption layer may be formed of desiccant material. Alternatively, the apparatus may include a layer of desiccant material formed on the absorption layer.

The apparatus may include a display and a processor that is configured to communicate with the display. The display may include the array of interferometric modulation subpixels. The processor may be configured to process image data. The apparatus may include a memory device that is configured to communicate with the processor. The apparatus may include a driver circuit configured to send at least one signal to the display and a controller configured to send at least a portion of the image data to the driver circuit. The apparatus may include an image source module configured to send the image data to the processor. The image source module may include at least one of a receiver, transceiver and transmitter. The apparatus may include an input device configured to receive input data and to communicate the input data to the processor.

Alternative devices are described herein. Some such devices include a substantially transparent first substrate and an array of interferometric modulation subpixels disposed on the substantially transparent substrate. The devices may include enclosing apparatus configured for forming an enclosure for the array of subpixels. The enclosing apparatus may be attached to the first substrate. The devices may include light absorption apparatus configured for absorbing light that enters the first substrate and passes between gaps in the interferometric modulation subpixels. The light apparatus may be formed on the enclosing apparatus. The light absorption apparatus may include electrically conductive apparatus configured for providing electrical communication with the interferometric modulation subpixels.

Various methods are described herein. Some such methods involve forming an array of interferometric modulation subpixels on a substantially transparent first substrate. The subpixels may include column electrodes and row electrodes. The column electrodes and row electrodes may be patterned to form gaps between adjacent column electrodes. The methods may involve attaching a second substrate to the first substrate to form an enclosure for the array of interferometric modulation subpixels. The second substrate may have an absorption layer formed thereon. The absorption layer may be configured to absorb light that enters the first substrate and passes between the column electrodes of the second layer.

Forming the array of interferometric modulation subpixels may involve forming an optical stack into row electrodes on the first substrate. The optical stack may include a first layer that is conductive and partially reflective. The methods may involve forming a plurality of support structures and forming a second layer into conductive and reflective column electrodes on the support structures.

Forming the optical stack on the first substrate may involve forming black mask material only in support structure areas. Forming the optical stack on the first substrate may involve forming black mask material in support structure areas and in interconnecting row areas.

The methods may involve forming the absorption layer on the second substrate. Forming the absorption layer on the second substrate may involve, e.g., a printing process. The absorption layer may be formed of desiccant material. Alternatively, the method may involve forming a layer of desiccant material on the absorption layer. Forming the absorption layer on the second substrate may involve forming conductive spacers configured for providing electrical communication between the absorption layer and the first layer. The absorption layer may be formed on the second substrate before attaching the second substrate.

The methods may involve forming a routing area outside the array of subpixels. Forming the absorption layer on the second substrate may involve forming conductive spacers configured for providing electrical communication between the absorption layer and the routing area.

Details of one or more implementations of the subject matter described in this specification are set forth in the accompanying drawings and the description below. Although the examples provided in this summary are primarily described in terms of MEMS-based displays, the concepts provided herein may apply to other types of displays, such as liquid crystal displays, organic light-emitting diode (“OLED”) displays and field emission displays. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 shows an example of a top view of one portion of a subpixel array.

FIG. 10 shows an example of a cross-section through a portion of the subpixel array of FIG. 9.

FIG. 11A shows an example of a black mask layer in the subpixel array of FIG. 9.

FIG. 11B shows an example of the M1 layer of FIG. 9.

FIG. 11C shows an example of the movable reflective layer of FIG. 9.

FIG. 12 shows an example of a black mask layer of an alternative subpixel array that lacks inter-post columns of black mask material.

FIG. 13 shows an example of a top view of one portion of a subpixel array that includes the black mask layer shown in FIG. 12.

FIG. 14 shows an example of a cross-section through a portion of the subpixel array of FIG. 13.

FIG. 15 shows an example of a black mask layer of an alternative subpixel array that includes neither inter-post columns nor inter-post rows of black mask material.

FIG. 16 shows an example of a top view of one portion of a subpixel array that includes the black mask layer shown in FIG. 15.

FIG. 17 shows an example of a cross-section through a portion of the subpixel array of FIG. 16.

FIG. 18 shows an example of a top view of one portion of a subpixel array that includes no black mask layer between the M1 layer and the array glass.

FIG. 19 shows an example of a cross-section through a portion of the subpixel array of FIG. 18.

FIG. 20 shows an example of a flow diagram illustrating a process of fabricating a subpixel array as described herein.

FIGS. 21A and 21B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

According to some implementations provided herein, an absorption layer may be formed on a back substrate of the apparatus thus preventing light transmitted through inter-post column areas from reflecting off of the back substrate and through the array glass. This may reduce the need for inter-post columns of black mask material in a subpixel array. Light entering the slots in the M1 layer and the areas between columns of the mechanical layer may then be absorbed by the absorption layer formed on the back substrate.

In alternative implementations, the black mask layer may only be formed in post areas of an array. Such implementations may lack inter-post columns and inter-post rows of black mask material. Other implementations may include no black mask material between the M1 layer and the array glass. Such implementations can further reduce the stiction of each subpixel by reducing the contouring of the M1 layer caused by the inter-post columns and/or rows of black mask material compared to a device having the inter-post and/or inter-post rows of black mask material. Similarly, such implementations can further increase the fill factor of the display by reducing the percentage of the display covered by black mask material. However, if the black mask material is formed into isolated portions or is absent, the absorption layer formed on the back substrate may include at least one highly conductive layer that can form part of the signal routing for the display. Alternatively, a conductive layer may be formed on top of the absorption layer. Conductive spacers may be formed to connect the conductive absorption layer or the overlying conductive layer to the rows of M1 material. Accordingly, the row electrodes of the subpixel array may include the M1 layer and the conductive absorption layer (or the overlying conductive layer). The conductive absorption layer or the overlying conductive layer may be formed into electrically isolated rows.

Particular implementations of the subject matter described in this disclosure can be implemented to realize one or more of the following potential advantages. In some implementations, the problem of increased stiction caused by gaps in the inter-post columns of black mask material may be reduced or eliminated. Moreover, because the amount of black mask material in the optical stack has been reduced or eliminated, the fill factor of the display may be increased.

One example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

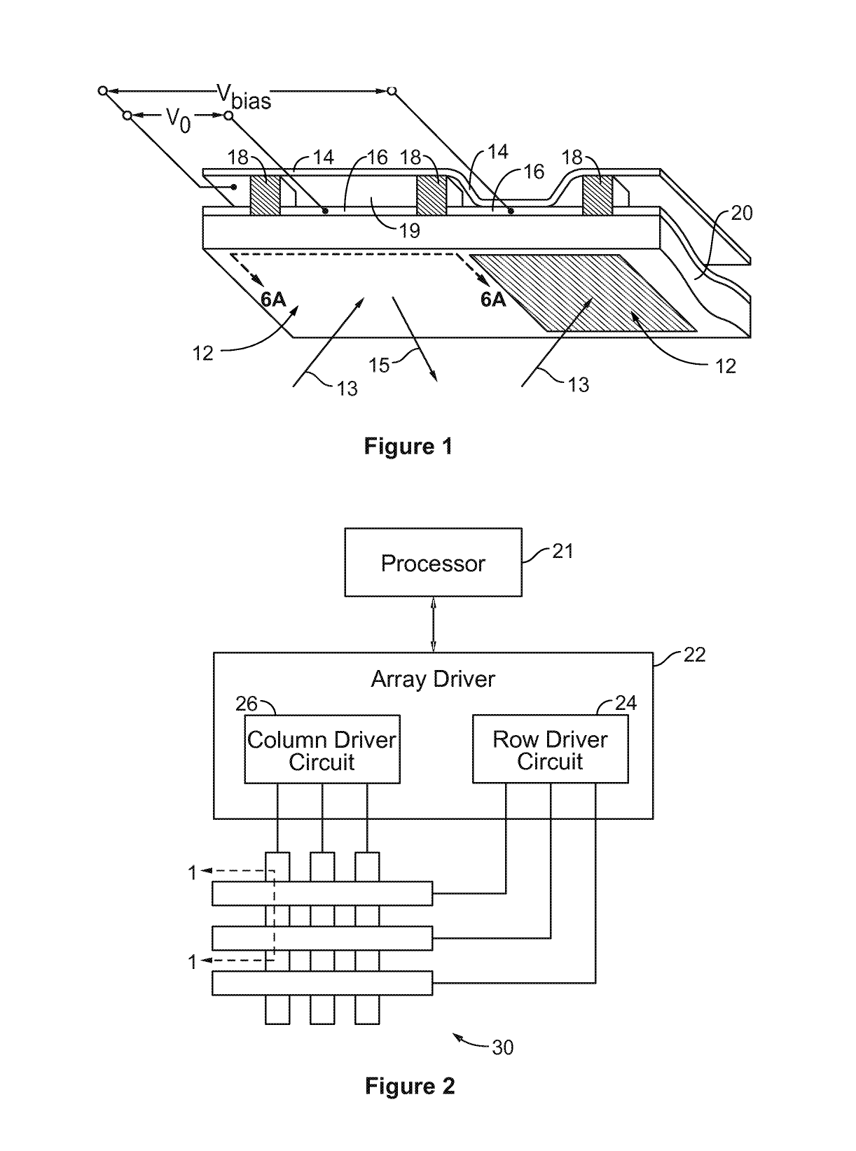

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the IMOD 12 on the left. Although not illustrated in detail, it will be understood by one having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the IMOD 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be on the order of 1-1000 um, while the gap 19 may be on the order of <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the IMOD 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated IMOD 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

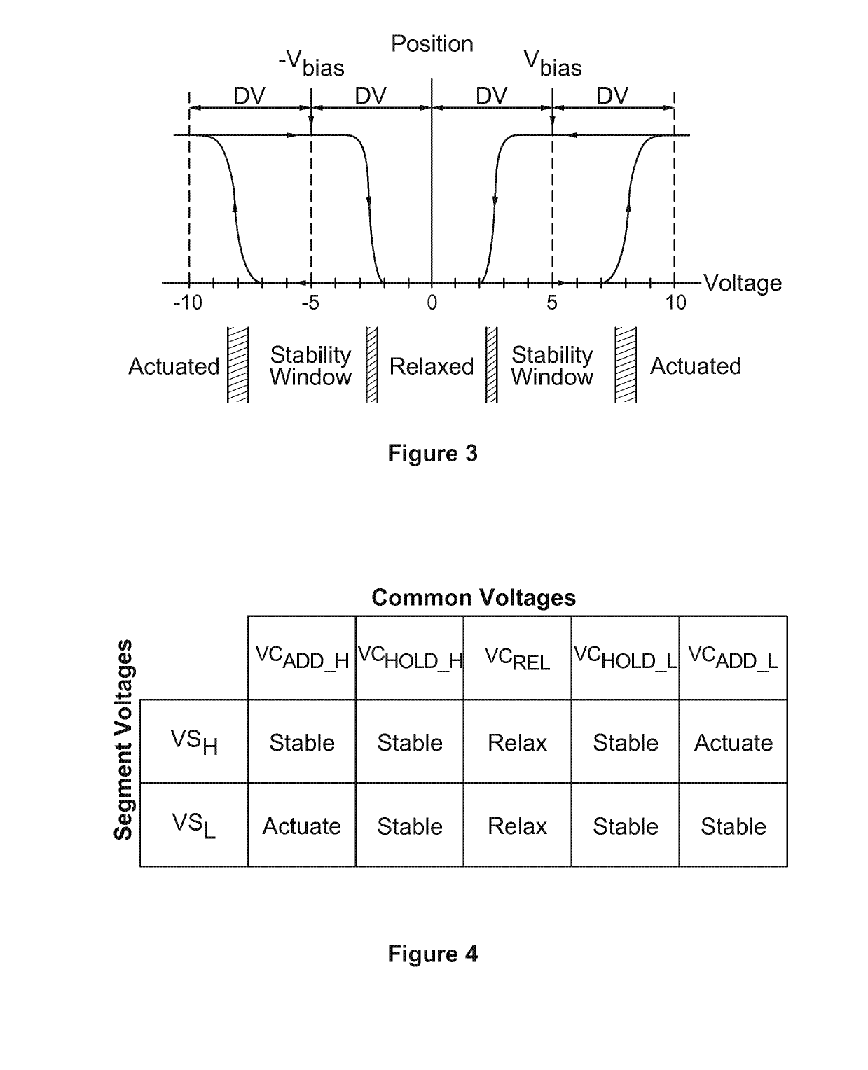

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may use, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10 volts, however, the movable reflective layer does not relax completely until the voltage drops below 2 volts. Thus, a range of voltage, approximately 3 to 7 volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10 volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7 volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

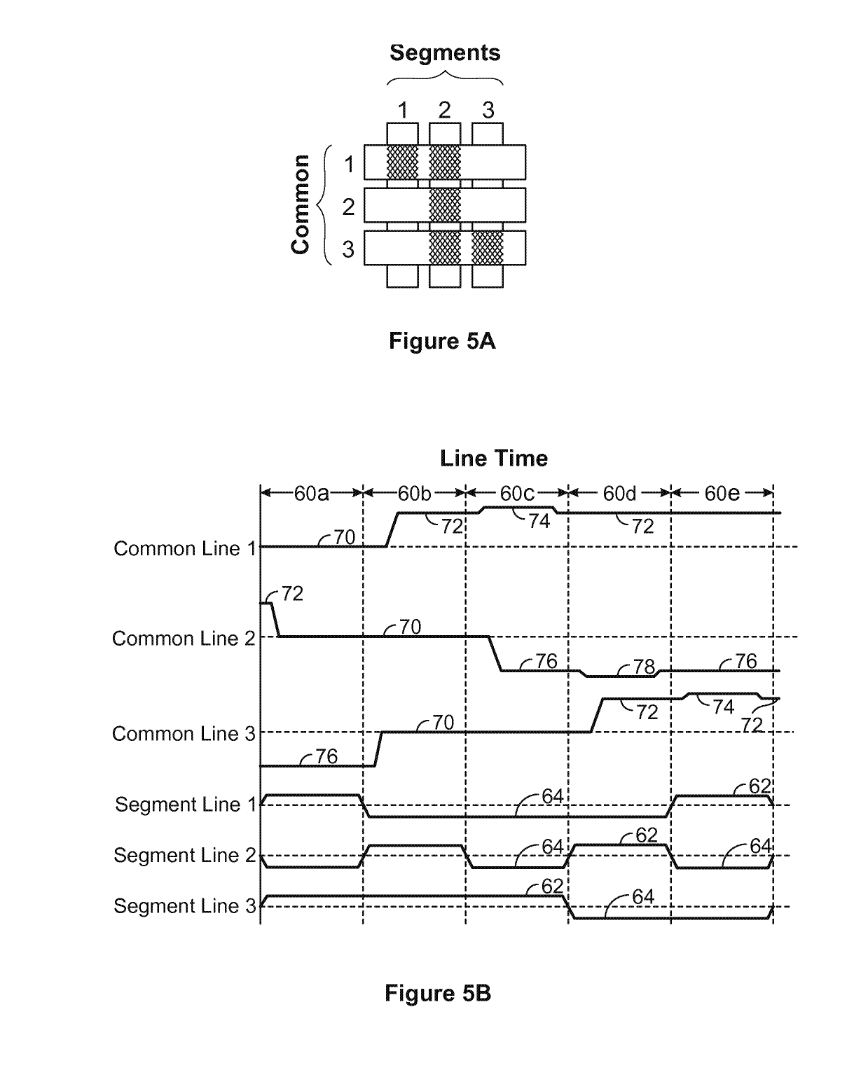

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a, a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}-relax and VC_{HOLD}_{_{—}}_{L}-stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

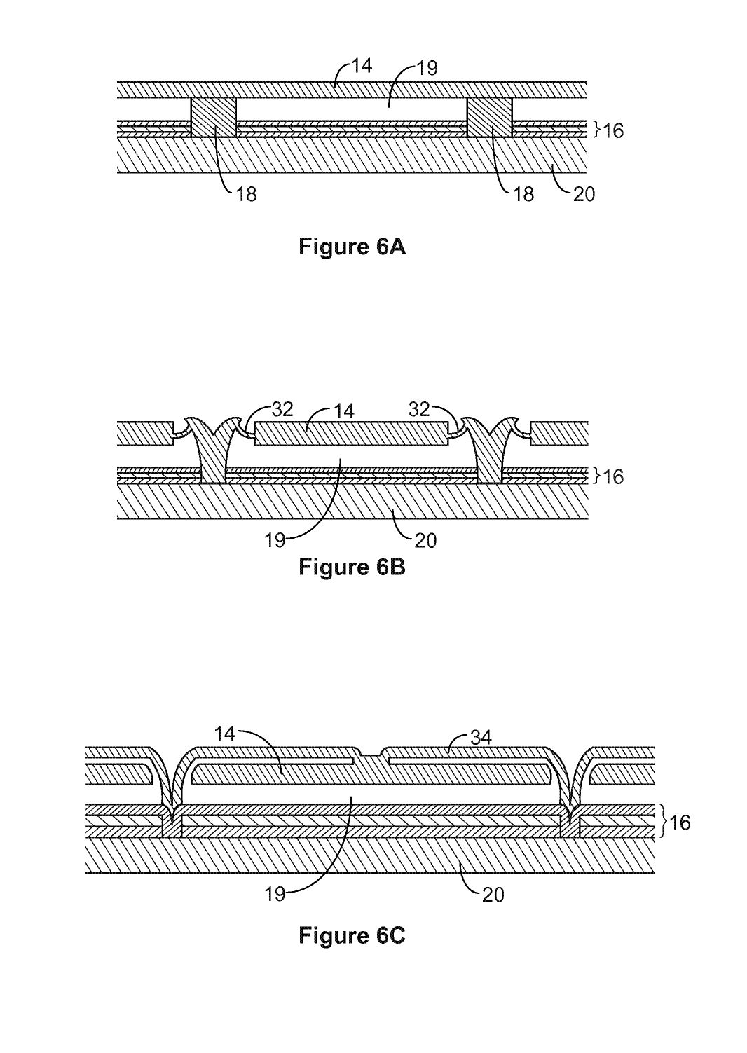

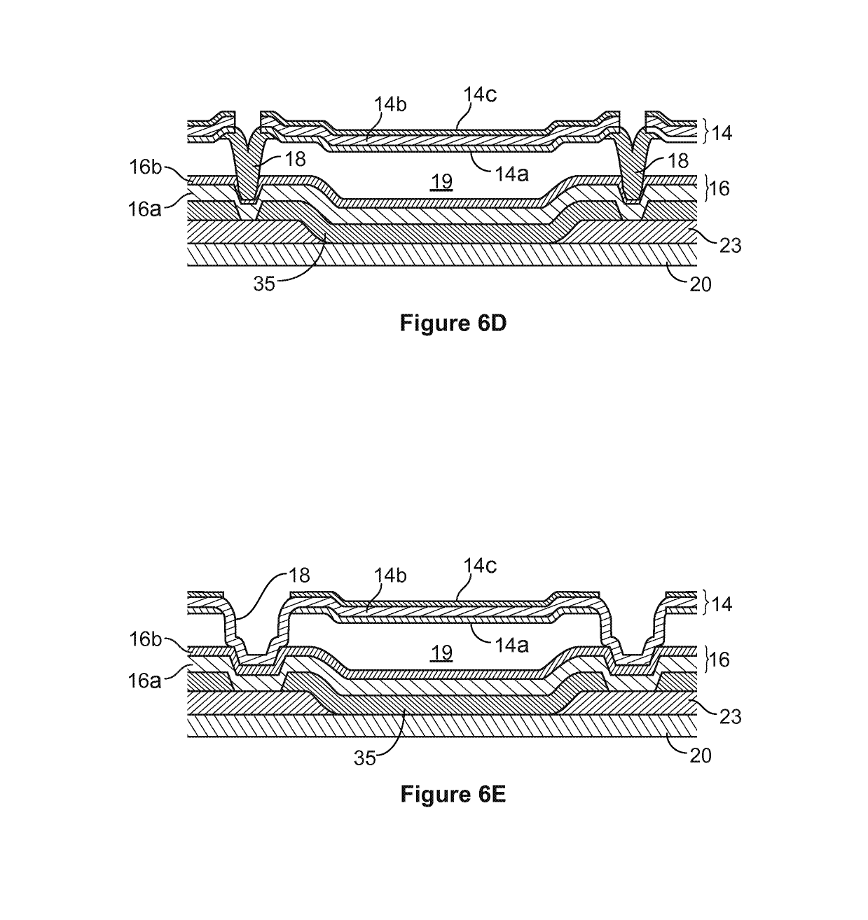

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, an SiO₂/SiON/SiO₂ tri-layer stack. Either or both of the reflective sub-layer 14a and the conductive layer 14c can include, e.g., an Al alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, an SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, CF₄ and/or O₂ for the MoCr and SiO₂ layers and Cl₂ and/or BCl₃ for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self-supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

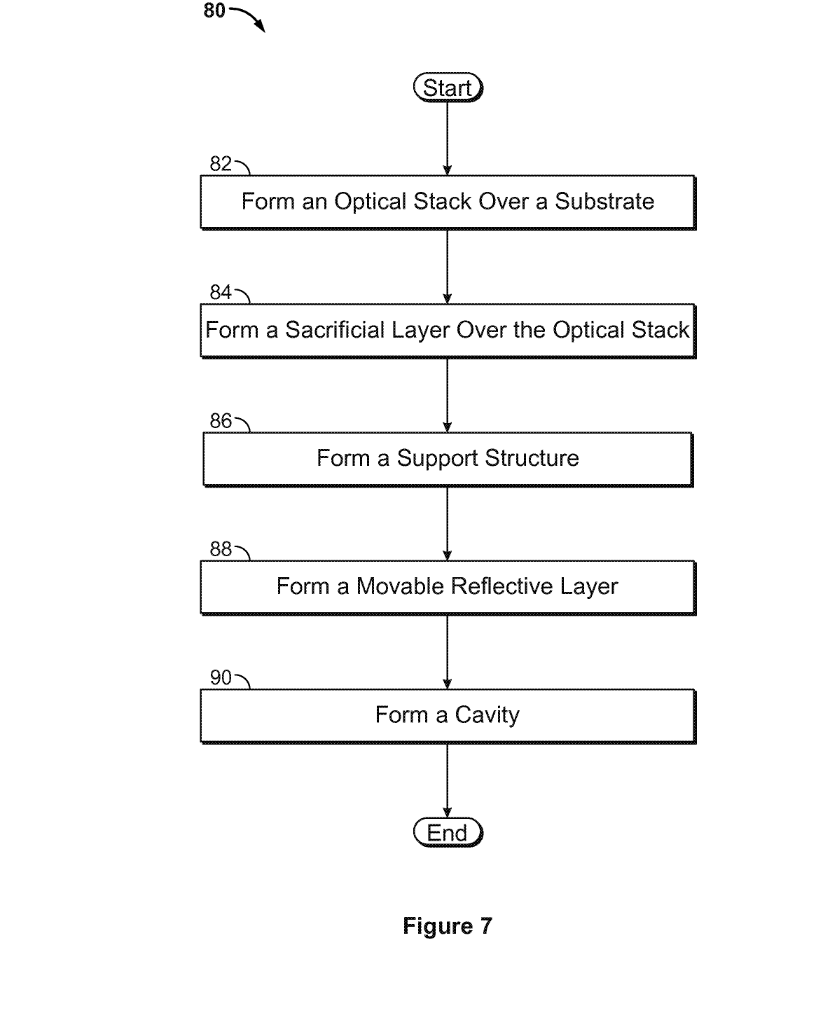

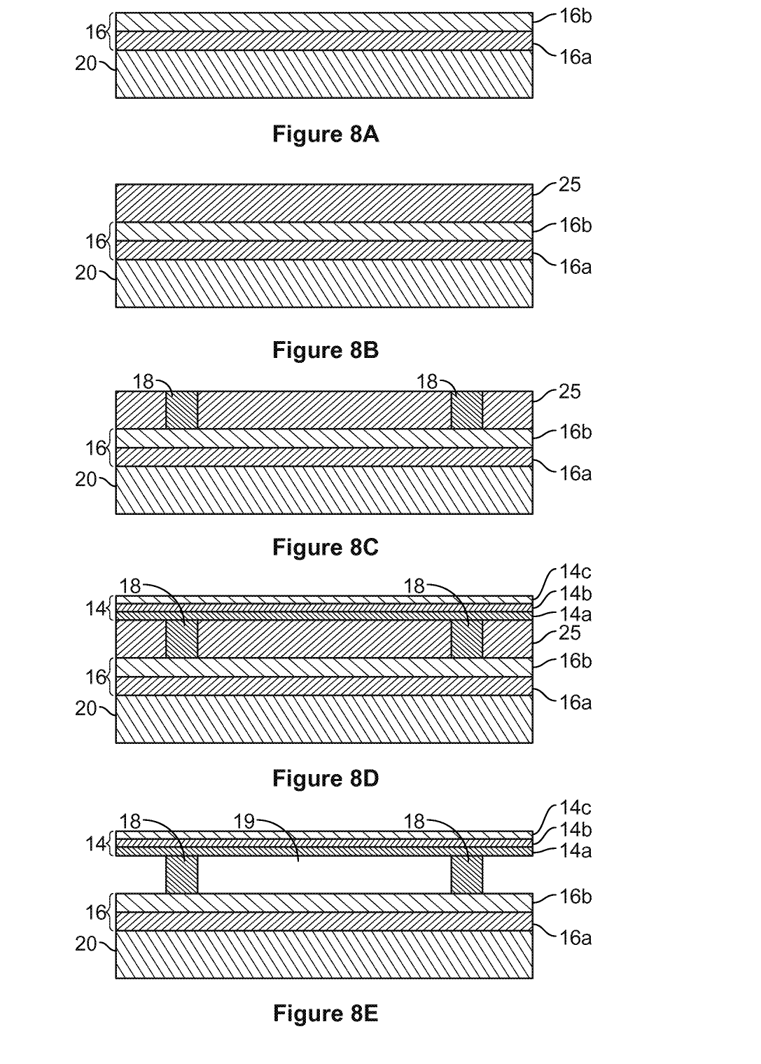

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition processes, e.g., reflective layer (e.g., aluminum, aluminum alloy) deposition, along with one or more patterning, masking, and/or etching processes. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other combinations of etchable sacrificial material and etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

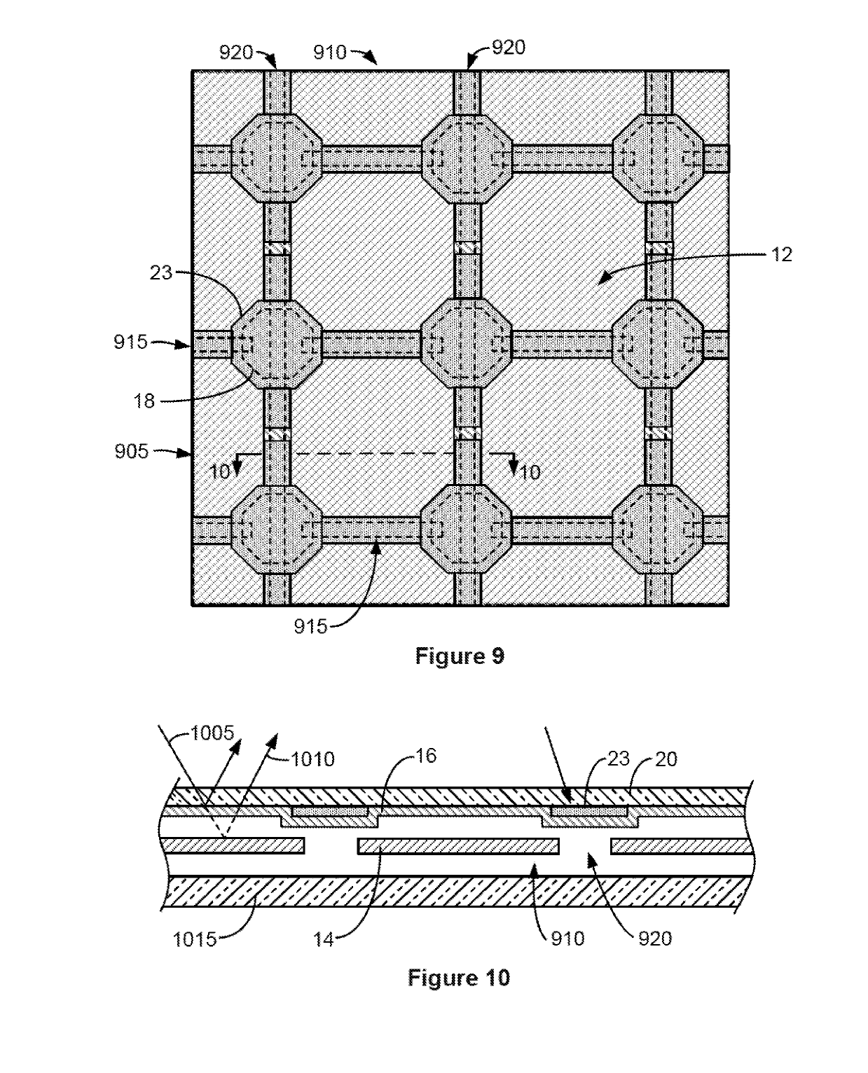

FIG. 9 shows an example of a top view of one portion of a subpixel array. As illustrated, the subpixel array is an interferometric modulation subpixel array. The posts 18 are disposed in corners of each of the subpixels 12. In this example, the electrode rows 905 include the M1 layer 16, which is partially reflective and partially conductive. Here, the electrode columns 910 include the movable reflective layer 14. The mech cuts 920 separate the electrode columns 910 from one another. The slot cuts 915 separate the electrode rows 905.

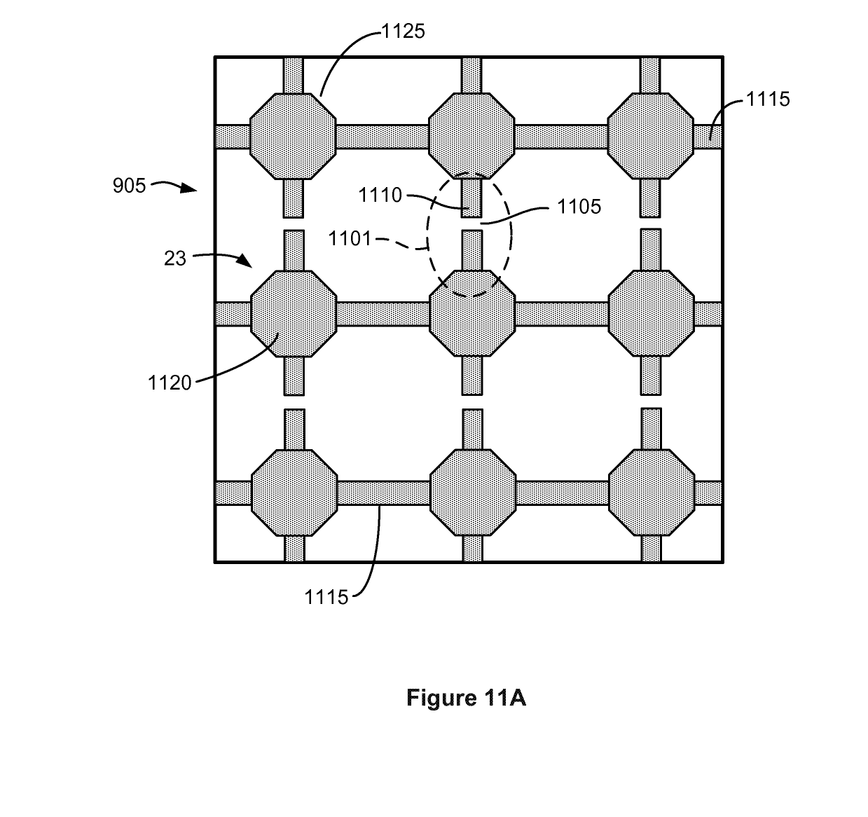

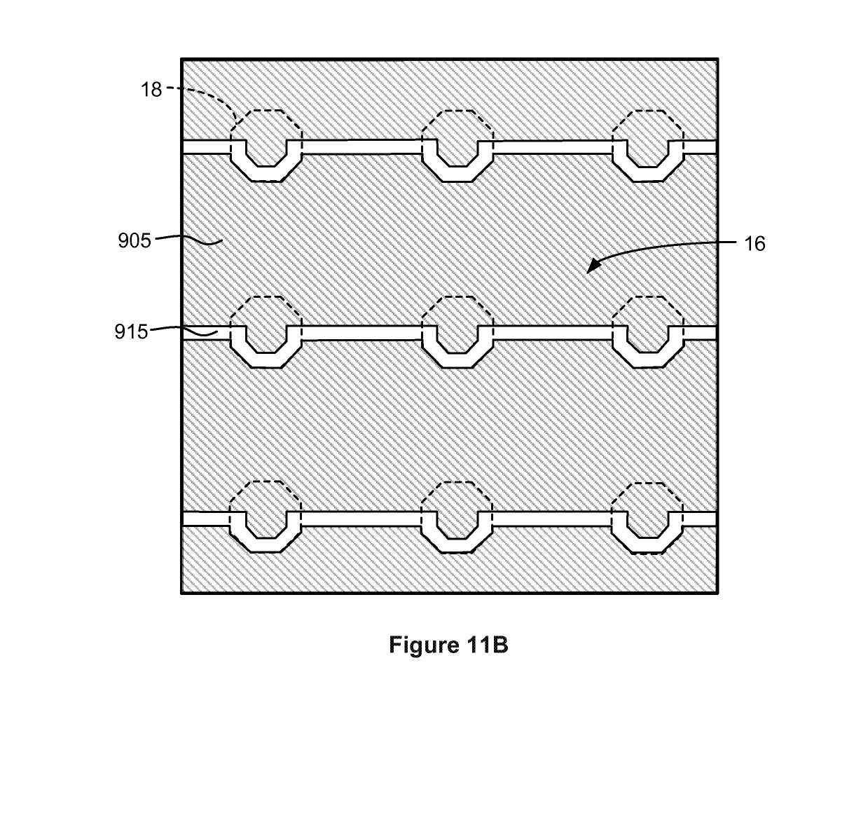

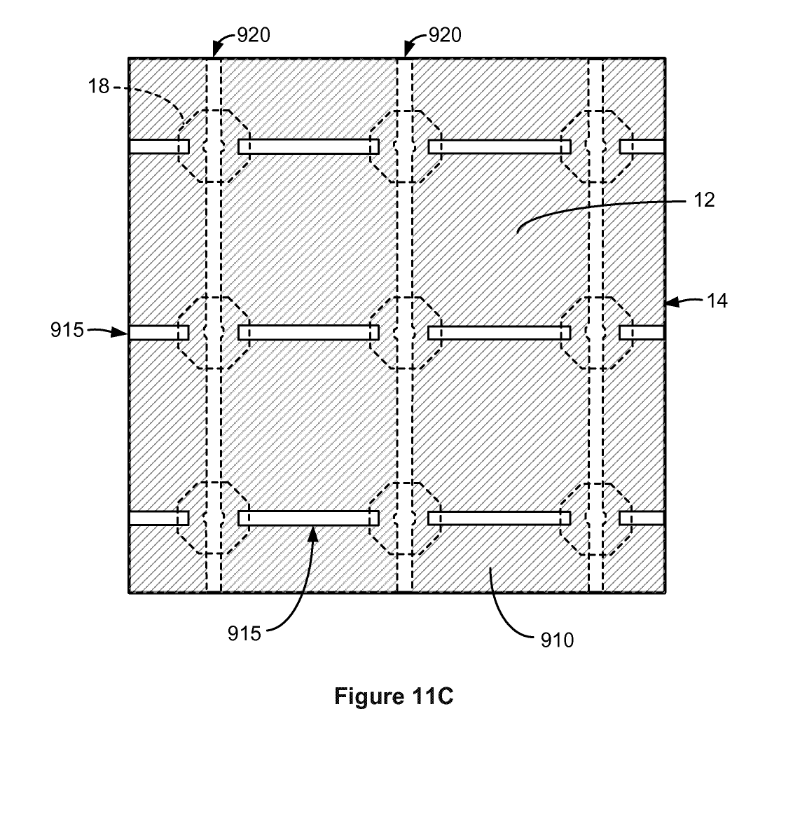

The underlying black mask structure 23, which is disposed between the M1 layer and the array glass 20 (not shown in FIG. 9) in this example, is electrically conductive and also forms part of the electrode rows 905. The underlying black mask structure 23 may be seen more clearly in FIG. 11A and will be discussed below with reference to that figure.

FIG. 10 shows an example of a cross-section through a portion of the subpixel array of FIG. 9. The dashed line in FIG. 9 indicates the location of the cross-section of FIG. 10.

In this example, the black mask structure 23 is formed on the substantially transparent substrate 20. Although the substrate 20 may be referred to herein as an “array glass,” the substrate 20 may be formed of any suitable substantially transparent material, such as the materials described above. Similarly, the back glass 1015, which forms, together with the array glass, a protective enclosure for the subpixel array, is not necessarily made of glass. The back glass 1015 may be formed of glass, metal, plastic, or other suitable material. In some implementations, the back glass 1015 may have a recess into which the display device may fit. Incident light 1005 may be partially reflected from the M1 layer 16. The reflected light 1010 from the M1 layer 16 may interfere constructively with the reflected light 1010 from the movable reflective layer 14.

However, the black mask structure 23 can cause destructive interference such that little or none of the incident light 1005 is reflected from the black mask structure 23. In the cross-section of FIG. 10, the black mask structure 23 prevents the incident light 1005 from entering the mech cuts 920 through the movable reflective layer 14 that separate the electrode columns 910. As shown in FIG. 10, columns of the black mask structure 23 may be made slightly wider than the mech cuts 920, in order to allow for possible misalignment or other imperfections in the fabrication process. For example, in some implementations the mech cuts 920 may be approximately 3 microns wide, whereas the black mask structure 23 may be 5 microns wide. (These dimensions are noted merely by way of example and are not to be construed as limiting in any way.) Because the black mask structure 23 will cover part of the active area of the subpixels 12 in such implementations, the fill factor of the display is correspondingly reduced.

FIG. 11A shows an example of a black mask layer in the subpixel array of FIG. 9. Within the dashed oval area 1101, one of the gaps 1105 in the inter-post columns 1110 of the black mask structure 23 may be seen. In this example, the gaps 1105 in the black mask structure 23 are formed to electrically isolate the electrode rows 905 from one another. By comparing FIG. 11A and FIG. 9, it may be seen that the gaps 1105 are formed across the mech cuts 920. However, due in part to the overlap of the movable reflective layer 14 by the black mask structure 23 (see FIG. 10), the gaps 1105 may cause some degree of local topography change. This local topography change can result in stiction of the movable reflective layer 14. Here, the M1 layer 16 extends over the gaps 1105 and prevents at least some of the incident light 1005 (see FIG. 10) from entering the gaps 1105.

In this example, the black mask structure 23 is also formed in the post areas 1120 and in the inter-post rows 1115. Forming the black mask structure 23 in such optically inactive regions can prevent ambient light from entering the slot cuts 915 or reflecting from the posts 18 (see FIG. 9). By inhibiting light from being reflected from or transmitted through inactive portions of the display, the black mask structure 23 can increase the contrast ratio of a display device that includes the subpixels 12. Here, the black mask structure 23 is also formed in the bending areas 1125, which are areas in which the movable reflective layer 14 bends over the posts 18 (see FIG. 1). In this example, the inter-post rows 1115 are continuous in order to provide electrical connectivity along the electrode rows 905.

FIG. 11B shows an example of the M1 layer of FIG. 9. In FIG. 11B, the electrode rows 905 may be more clearly seen than in FIG. 9. The slot cuts 915, which are formed around posts 18 in this example, separate the electrode rows 905.

FIG. 11C shows an example of the movable reflective layer of FIG. 9. The mech cuts 920 separate the electrode columns 910 from one another. The slot cuts 915 extend through the movable reflective layer 14 between the posts 18, providing some degree of mechanical decoupling between portions of the movable reflective layer 14 in adjacent subpixels 12. However, the slot cuts 915 do not extend across the entire width of the electrode columns 910 in this example. Therefore, the movable reflective layer 14 is configured for electrical communication along the electrode columns 910.

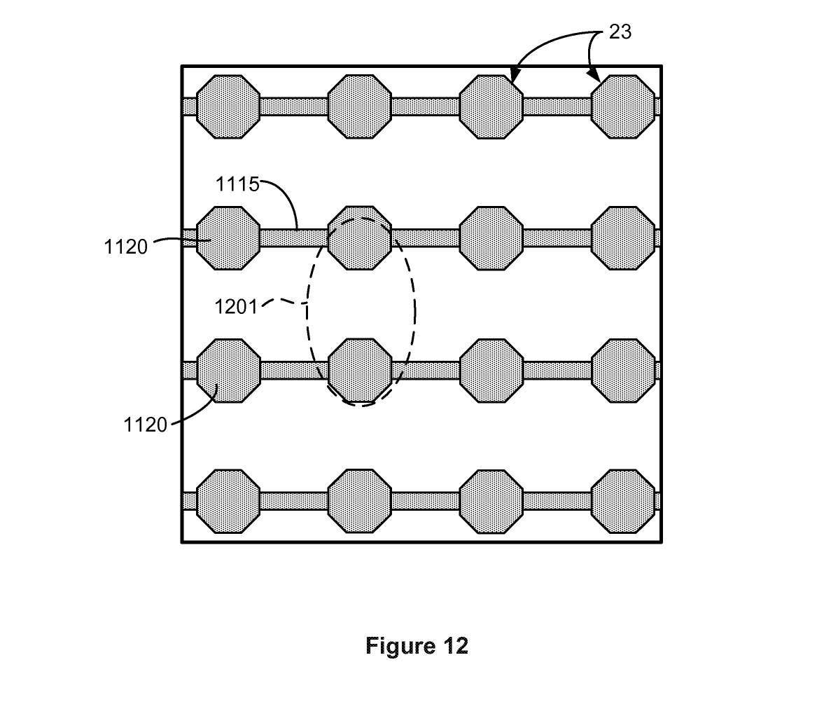

FIG. 12 shows an example of a black mask layer of an alternative subpixel array that lacks inter-post columns of black mask material. Within the dashed oval area 1201, for example, no inter-post column 1110 of the black mask structure 23 has been formed. By omitting the inter-post columns 1110 of the black mask structure 23, the local topography changes caused by the gaps 1105 are also eliminated. Accordingly, such implementations can result in a reduced level of stiction for the movable reflective layer 14.

In this example, the black mask structure 23 is not formed in the bending areas 1125 of the post areas 1120. However, alternative implementations may lack the inter-post columns 1110 but may nonetheless include the black mask structure 23 in the bending areas 1125.

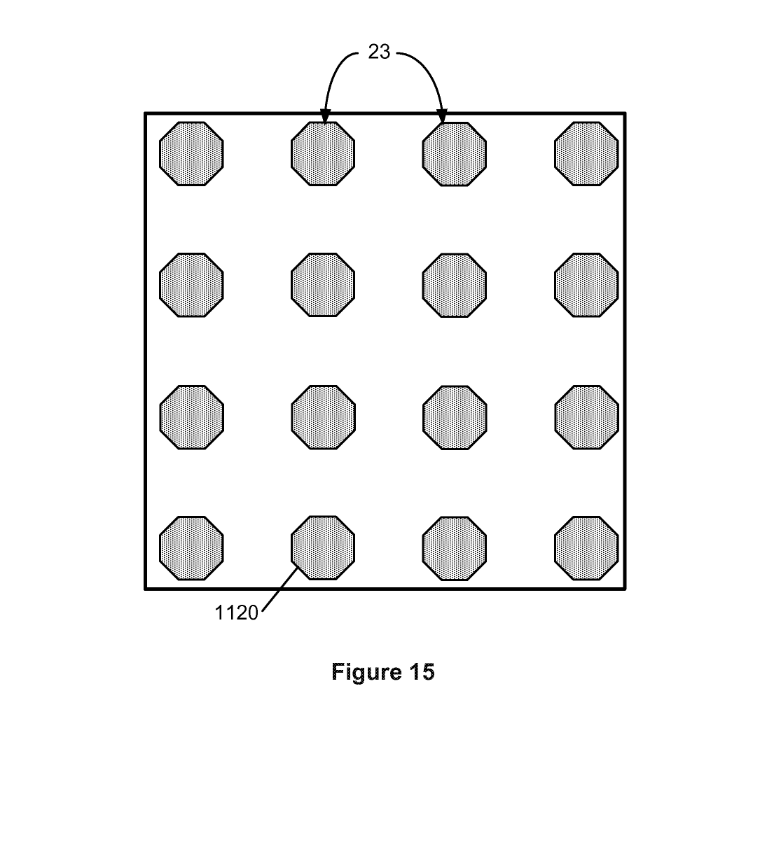

As in the previous example, the inter-post rows 1115 are continuous in order to provide electrical connectivity along the electrode rows 905. As described in more detail below with reference to FIG. 14, the inter-post rows 1115 are not required for absorbing incident light 1005 that enters the subpixel array between the subpixels 12 because an absorption layer has been formed on the back glass 1015. Therefore, in some implementations, the inter-post rows 1115 may be made narrower than those described with reference to FIG. 11 because the inter-post rows 1115 do not need to overlap the active area of the subpixels 12. Because the black mask structure 23 does not need to cover any part of the active area of the subpixels 12 in such implementations, the fill factor of the display may be correspondingly increased.

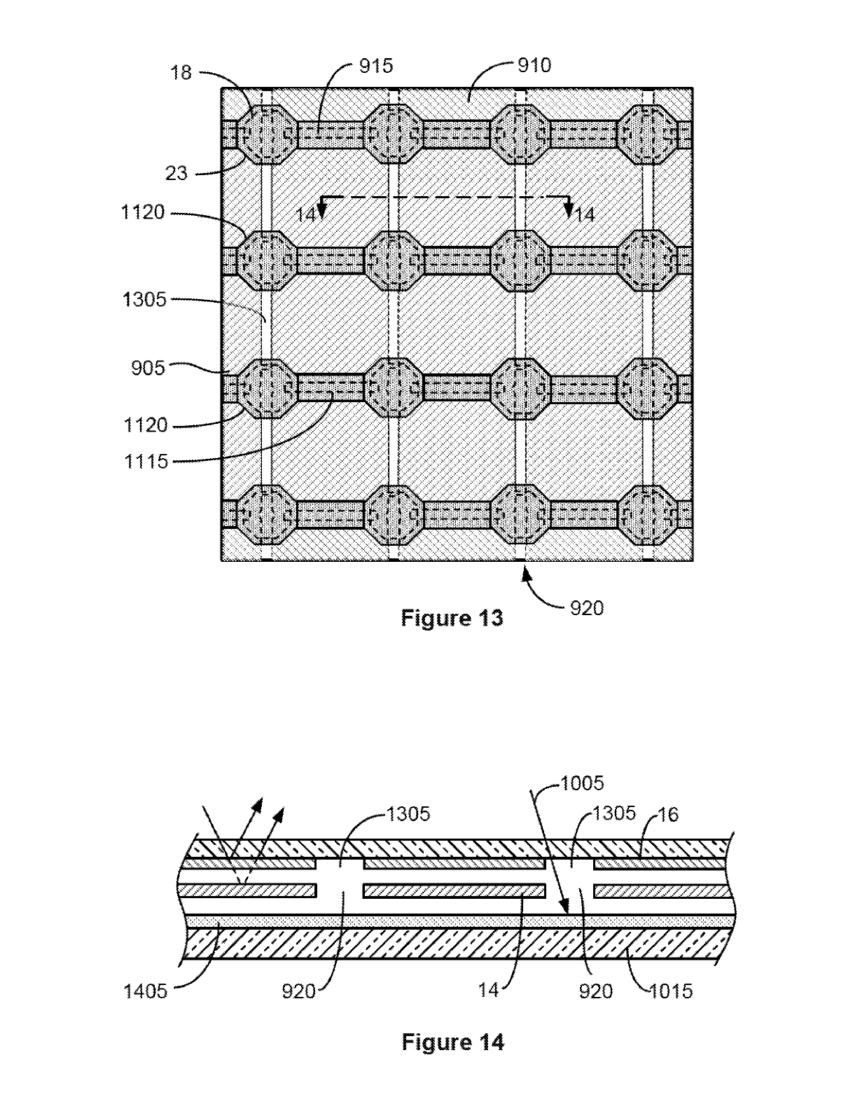

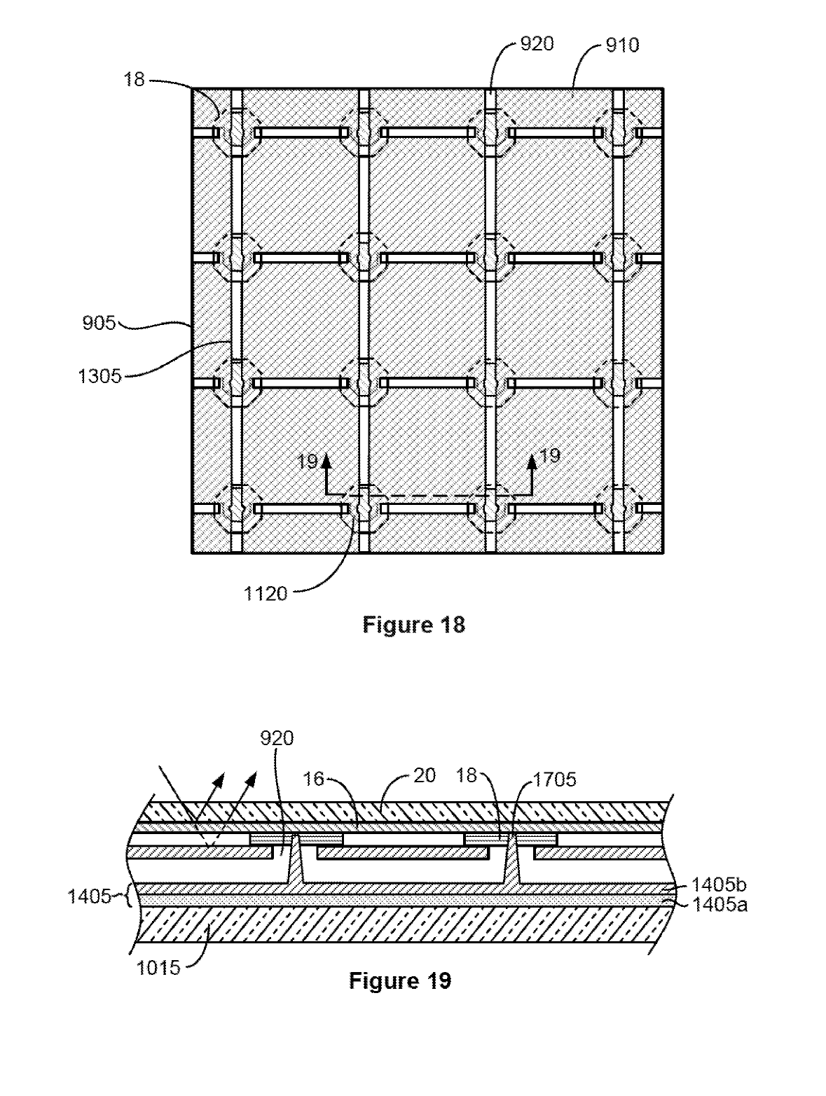

FIG. 13 shows an example of a top view of one portion of a subpixel array that includes the black mask layer shown in FIG. 12. The M1 layer 16 and the movable reflective layer 14 depicted in FIG. 13 are substantially as shown in FIGS. 11B and 11C, respectively. However, in this example, the electrode rows 905 include slots 1305. Slots 1305 may be seen even more clearly in FIG. 18, because there is no black mask structure 23. Referring again to FIG. 13, the slots 1305 line up with the mech cuts 920, which separate the electrode columns 910. However, in alternative implementations the electrode rows 905 do not include the slots 1305. Slot cuts 915, mech cuts 920, and/or slots 1305 may form gaps in the subpixel array through which ambient light that enters the substrate 12 may pass. Such light may then reflect off of a back glass 1015 and degrade the performance of the device. Outlines of the post areas 1120 of the black mask structure 23 may also be seen in FIG. 13.

FIG. 14 shows an example of a cross-section through a portion of the subpixel array of FIG. 13. The dashed line in FIG. 13 indicates the location of the cross-section of FIG. 14. Here, the cross-section spans an area of the subpixel array that does not include the black mask structure 23, because no inter-post columns 1110 of the black mask structure 23 have been formed.

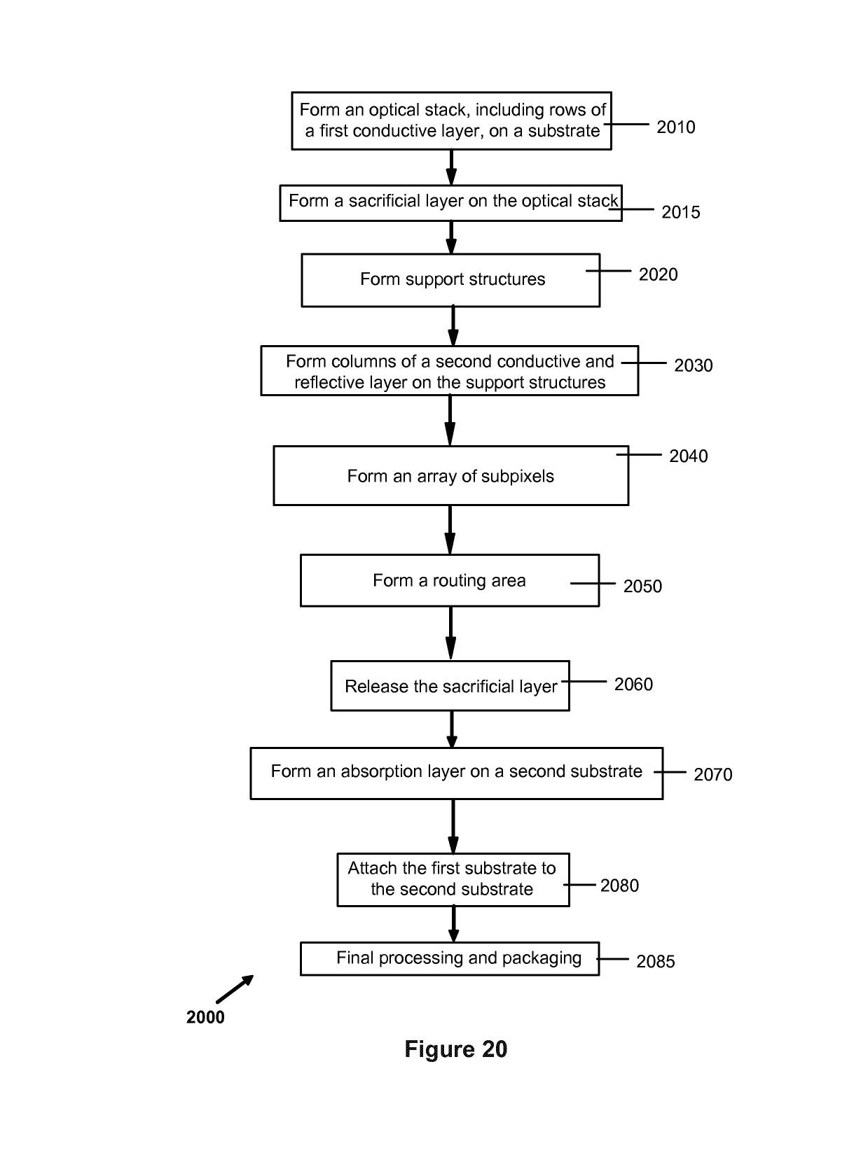

In this implementation, incident light 1005 may enter the slots 1305 in the M1 layer 16. The incident light 1005 may also enter the mech cuts 920 in the movable reflective layer 14. Such incident light 1005 may be absorbed by the absorption layer 1405, which is disposed upon the back glass 1015 in this example. The absorption layer 1405 may be formed, for example, from any suitable darkly-pigmented material, such as black paint, a black resin, etc. In some implementations, the absorption layer 1405 may be formed from a pigmented polymer resin, such as a polyimide-based resin that has been pigmented to achieve a high degree of opacity. The absorption layer 1405 may be formed according to any appropriate process, such as a printing process, a spin-coating process, etc. In some implementations, a black desiccant may function as the absorption layer 1405. For example, a black desiccant may be formed from carbon, calcium oxide and a binder. Alternatively, a layer of desiccant may be formed on the absorption layer 1405. Some examples of device fabrication are provided below with reference to FIG. 20.

In other implementations, the back glass 1015 may function as the absorption layer 1405. For example, the back glass 1015 may be formed of a light-absorbing material. Alternatively, or additionally, the back glass 1015 may be formed of a substantially transparent material and may have a light-absorbing outer surface.

FIG. 15 shows an example of a black mask layer of an alternative subpixel array that includes neither inter-post columns nor inter-post rows of black mask material. Inter-post columns or inter-post rows of black mask material may refer to columns or rows of black mask material that is formed between posts. In this example, the black mask structure 23 is formed only in the post areas 1120. Because this implementation includes neither the inter-post columns 1110 nor the inter-post rows 1115, local topology changes and the associated stiction of the movable reflective layer 14 may be further reduced.

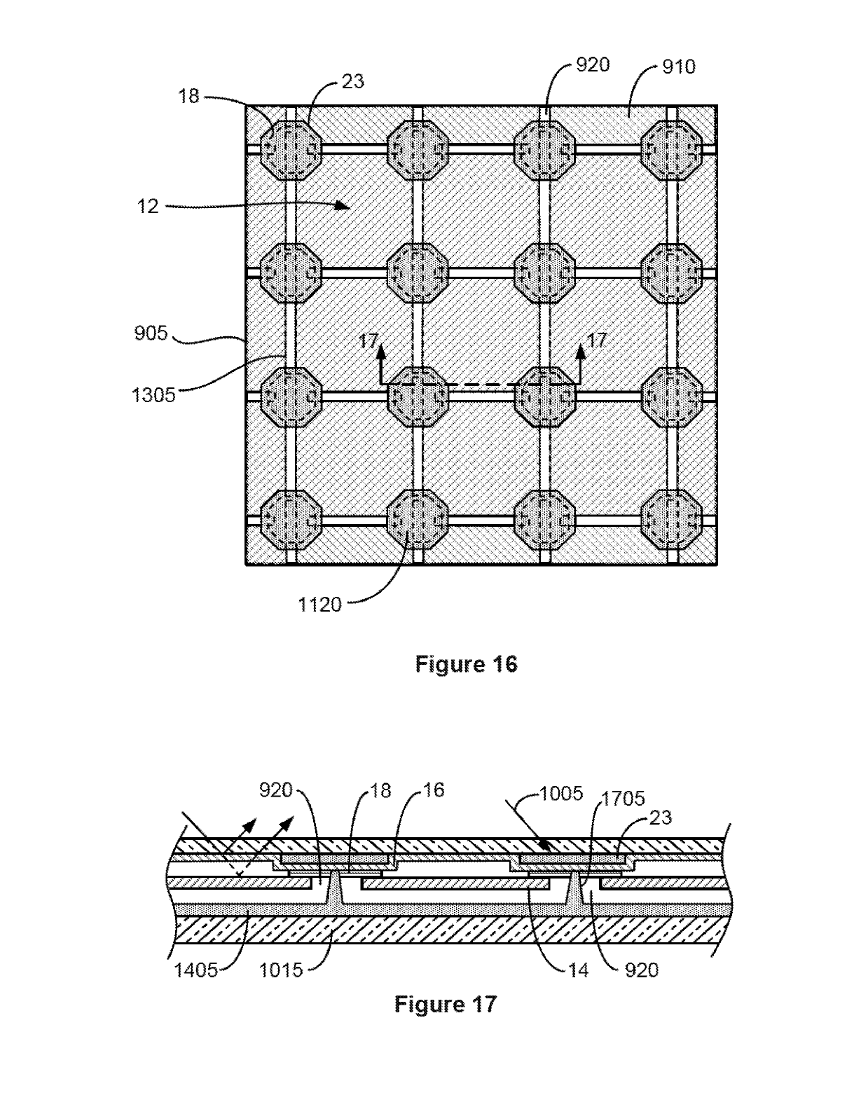

FIG. 16 shows an example of a top view of one portion of a subpixel array that includes the black mask layer shown in FIG. 15. Outlines of the post areas 1120 of the black mask structure 23 may be seen where the electrode rows 905 intersect with the electrode columns 910.

FIG. 17 shows an example of a cross-section through a portion of the subpixel array of FIG. 16. The dashed line in FIG. 16 indicates the location of the cross-section of FIG. 17. Here, the cross-section spans an area of the subpixel array that transects the post areas 1120 of the black mask structure 23 and two of the mech cuts 920. However, the M1 layer 16 is continuous in this cross-section, because the cross-section does not transect the corresponding slots 1305.

In an implementation such as that depicted in FIGS. 13 and 14, it is not necessary for the absorption layer 1405 to be conductive, because the black mask structure 23 is continuous along the inter-post rows 1115 and the post areas 1120 (see FIG. 13). Therefore, the black mask structure 23 can provide electrical connectivity along the electrode rows 905. However, in the implementation shown in FIGS. 15 through 17, the post areas 1120 of the black mask structure 23 are isolated from one another. Although the M1 layer 16 is at least partially conductive, in some such implementations, the M1 layer 16 may not be sufficiently conductive to provide adequate routing along the electrode rows 905. Hence, in some implementations, the absorption layer 1405 may include a conductive material or layer that is in electrical communication with the M1 layer. In such implementations, the absorption layer 1405 may therefore be in electrical communication with the subpixels 12 since the subpixels 12 are individually addressed by exerting a voltage difference between the electrode rows 905 and the electrode columns 910.

Therefore, in the implementation of FIGS. 15 through 17, the absorption layer 1405 is formed at least in part from conductive material. Here, conductive spacers 1705 are configured for providing electrical communication between the conductive absorption layer 1405 and the M1 layer 16. In this example, the conductive spacers 1705 extend through the mech cuts 920 in the movable reflective layer 14. The conductive absorption layer 1405 may be formed, for example, as a black mask structure such as the black mask structure 23, described above. For example, in some implementations the conductive absorption layer 1405 may include a molybdenum-chromium (MoCr) layer that serves as an optical absorber, an oxide layer (such as an SiO₂ layer) and an aluminum or chromium alloy that serves as a reflector and a bussing layer. In this example, the conductive spacers 1705 are formed as part of, or along with, the conductive absorption layer 1405 on the back glass 1015. In some implementations, a conductive bussing layer of the conductive absorption layer 1405 may extend to the top of the conductive spacers 1705, in order to provide an electrical connection between the conductive absorption layer 1405 and the overlying layer 16. In the areas of the conductive spacers 1705, additional material, such as additional oxide material, may be formed underneath the bussing layer of the conductive absorption layer 1405. In alternative implementations, the conductive spacers 1705 may be formed on the M1 layer 16. Some examples of device fabrication are provided below with reference to FIG. 20.

FIG. 18 shows an example of a top view of one portion of a subpixel array that includes no black mask layer between the M1 layer and the array glass, but with an absorption layer formed on the back glass 1015. FIG. 19 shows an example of a cross-section through a portion of the subpixel array of FIG. 18. The dashed line in FIG. 18 indicates the location of the cross-section of FIG. 19. Here, the cross-section spans an area of the subpixel array that transects two of the mech cuts 920. However, the M1 layer 16 is continuous in this cross-section, because the cross-section does not transect the corresponding slots 1305. The black mask structure 23 is not formed between the M1 layer 16 and the array glass 20 in this implementation.

In this implementation, the absorption layer 1405 includes a light-absorbing layer 1405a and an overlying substantially transparent and conductive layer 1405b. The light-absorbing layer 1405a may be formed, for example, from any suitable darkly-pigmented material, such black paint, a black resin, etc. In some implementations, the light-absorbing layer 1405a may be formed from a pigmented polymer resin, such as a polyimide-based resin. Layer 1405b may be formed of any suitable substantially transparent and conductive material, such as ITO. Here, the conductive spacers 1705 extend through the mech cuts 920 in the movable reflective layer 14. In this example, the conductive spacers 1705 are formed as part of, or along with, the substantially transparent and conductive layer 1405b. The light-absorbing layer 1405a is formed on the back glass 1015. In alternative implementations, the conductive spacers 1705 may be formed on the M1 layer 16.

In the implementation depicted in FIGS. 18 and 19, the black mask structure 23 is not required. This may be true, for example, if the subpixel posts are formed of substantially transparent material, of non-reflective material, etc. However, in alternative implementations, the subpixel posts may be reflective. In such implementations, some black mask material may be formed in the post areas of the subpixel array. For example, black mask material may be formed on the upper surface of the substrate 20. In some such implementations, the M1 layer 16 may be formed on one side of the substrate 20 and black mask material may be formed on an opposing side of the substrate 20 in the post areas of the subpixel array.

FIG. 20 shows an example of a flow diagram illustrating a process of fabricating a subpixel array as described herein. The blocks of process 2000, like those of other processes described herein, are not necessarily performed in the order indicated. For example, the operations of block 2070 may be performed before or after those of blocks 2010 through 2060. Alternative implementations of process 2000 may involve more or fewer blocks than are shown in FIG. 20.

In block 2010, an optical stack is formed on a substantially transparent substrate. The substrate may be a transparent substrate such as glass or plastic. In this example, the optical stack is partially transparent and partially reflective, and includes rows of a first conductive layer. The optical stack may be fabricated, for example, by depositing one or more layers having the desired properties onto the transparent substrate. The optical stack may be referred to herein as the M1 layer.

In block 2015 of process 2000, one or more sacrificial layers are formed on the optical stack. The sacrificial layer is later removed (at block 2060) to form a cavity.

In block 2020 of FIG. 20, support structures are formed on the optical stack. Block 2020 may involve forming posts, such as the posts 18 described above. The formation of the posts may include patterning the sacrificial layer to form a support structure aperture, then depositing a material (e.g., a polymer or an inorganic material, e.g., silicon oxide) into the aperture to form the posts, using a deposition method such as PVD, PECVD, thermal CVD, or spin-coating. In some implementations, as shown in FIG. 1, the support structure aperture formed in the sacrificial layer can extend through both the sacrificial layer and the optical stack to the underlying substrate, so that the lower end of the posts contact the substrate. Alternatively, as depicted in FIG. 8C, the aperture formed in the sacrificial layer may extend through the sacrificial layer, but not through the optical stack.

In block 2030, a second conductive layer is formed on the support structures. Here, the second conductive layer is a reflective layer. The second conductive layer may be formed by employing one or more deposition processes, along with one or more patterning, masking, and/or etching processes. In some implementations, the second conductive layer may include a plurality of sub-layers.

Although blocks 2040, 2050 and 2060 are shown as sequential blocks in FIG. 20, in some implementations they may be performed at substantially the same time. For example, blocks 2040, 2050 and 2060 may be performed as the corresponding features are formed on different areas of a substrate at substantially the same time. In block 2040, an array of subpixels is formed. For example, the subpixels may be substantially similar to the subpixels 12 shown in FIG. 13, FIG. 15 or FIG. 18. The subpixels may be configured to move the second layer when a voltage is applied between the second conductive layer and the first conductive layer.

In this example, a routing area is formed in block 2050. The routing area may be used to supply power and to connect various devices, such as those described below with reference to FIGS. 18A and 18B, to the subpixel array. The routing area may include features similar to those described above with reference to FIG. 2, such as array driver 22, row driver circuit 24 and column driver circuit 26.

In block 2060, the sacrificial layer is released to form an optical cavity between the optical stack and the second conductive layer. The second conductive layer of each active subpixel may be configured to be movable relative to the optical stack when a sufficient voltage is applied between the first conductive layer and the second conductive layer.

In block 2070, an absorption layer is formed on a second substrate. In some implementations, the second substrate may be substantially similar to the back glass described above. In some implementations, the absorption layer is configured to provide electrical connectivity between the routing area and the first conductive layer. In alternative implementations, the absorption layer is formed on the second substrate and includes an overlying conductive layer formed on a light-absorbing layer. The overlying conductive layer may be substantially transparent, so that incident light can pass through the overlying conductive layer and be absorbed by the light-absorbing layer. The absorption layer may be formed according to any appropriate process, such as a printing process, a spin-coating process, etc. In some implementations, a black desiccant may function as the absorption layer. Alternatively, a layer of desiccant may be formed on the absorption layer or on an overlying conductive layer. In some implementations, block 2070 may involve forming a multi-layer black mask structure such as the black mask structure 23, described above.

In some implementations, block 2070 involves forming conductive spacers that are configured for providing electrical communication between the conductive layer and the M1 layer. According to some such implementations, a conductive bussing layer of the conductive absorption layer may extend to the top of the conductive spacers, in order to provide an electrical connection between the conductive absorption layer and the overlying layer. In the areas of the conductive spacers, additional material, such as additional oxide material, may be formed underneath the bussing layer of the conductive absorption layer. In alternative implementations, the conductive spacers may be fabricated by forming a substantially transparent and conductive material, such as ITO, on a post that includes black mask material. The underlying post may, for example, include a silicon oxide formed via a high aspect ratio fabrication process, such as a deep reactive ion etching process.

In block 2080, the first substrate is attached to the second substrate. In some implementations, block 2080 involves configuring the conductive spacers for electrical communication with the M1 layer. Moreover, block 2080 may involve configuring a conductive absorption layer or an overlying conductive layer for electrical communication with the routing area formed in block 2050. In some such implementations, conductive spacers may form an electrical connection between a conductive absorption layer (or an overlying conductive layer) and the routing layer. Block 2080 may involve attaching components in any appropriate manner, e.g., via solder flow processes and/or cementing processes.

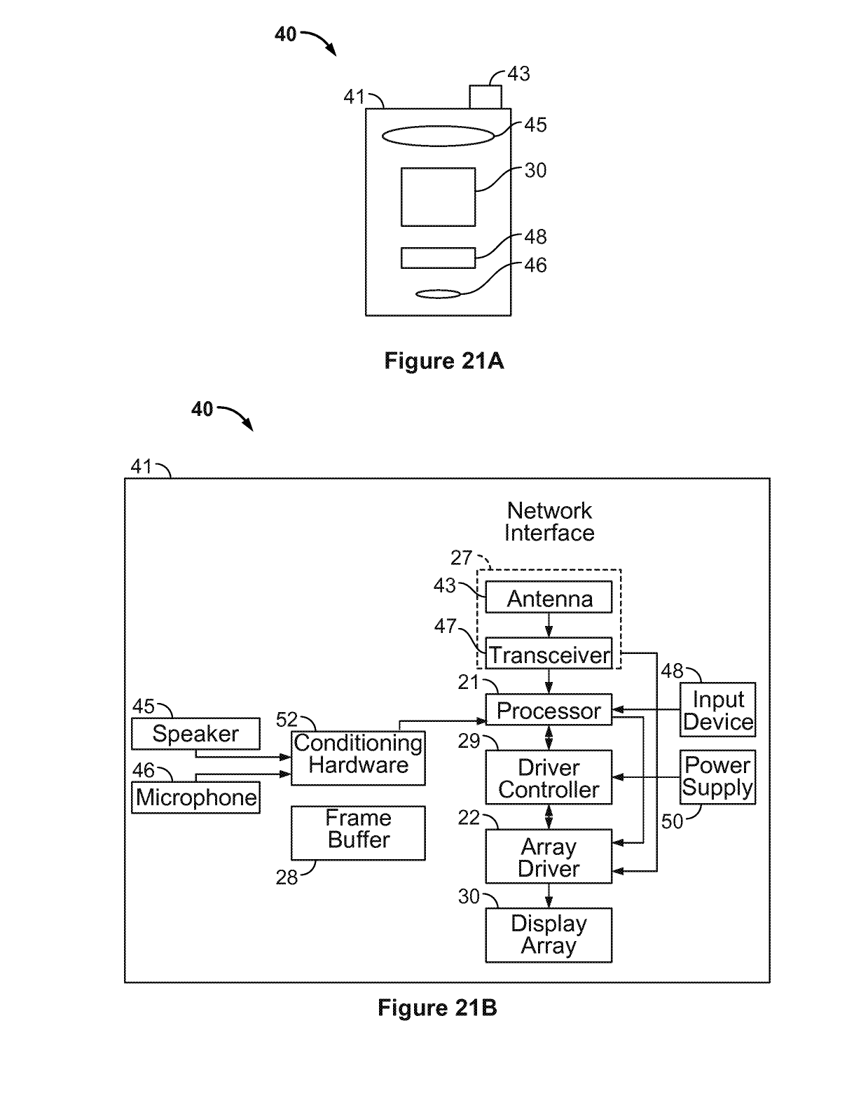

In block 2085, final processing and packaging operations may be performed. For example, individual displays may be singulated. Processors, driver controllers, etc., may be electrically connected with the routing area. The resulting display devices may be incorporated into a portable device, e.g., a device such as that described below with reference to FIGS. 21A and 21B.

FIGS. 21A and 21B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 21B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43. The processor 21 may be configured to receive time data, e.g., from a time server, via the network interface 27.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone integrated circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein.

The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD (or any other device) as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus, comprising:
a substantially transparent first substrate;
an array of interferometric modulation subpixels disposed on the substantially transparent substrate;
a second substrate attached to the first substrate and configured to form an enclosure for the array of interferometric modulation subpixels; and
an absorption layer formed on the second substrate, the absorption layer configured to absorb light that enters the substantially transparent first substrate and passes between gaps in the array of interferometric modulation subpixels.

2. The apparatus of claim 1, wherein each of the subpixels include a mechanical reflective layer formed into column electrodes and a partially reflective layer formed into row electrodes, wherein the column electrodes and the row electrodes are patterned to form the gaps.

3. The apparatus of claim 2, further comprising:
a plurality of posts configured to support edges of the mechanical reflective layer; and
black mask material formed in some areas of some of the posts.

4. The apparatus of claim 3, wherein the black mask material is configured for electrical communication with the partially reflective layer and forms part of the row electrodes.

5. The apparatus of claim 3, wherein the black mask material is formed only in the areas of the posts.

6. The apparatus of claim 3, wherein the black mask material is formed in the areas of the posts and in row areas between the posts.

7. The apparatus of claim 3, wherein the black mask material is formed between the first substrate and the partially reflective layer.

8. The apparatus of claim 1, wherein the absorption layer is configured for electrical communication with the interferometric modulation subpixels.

9. The apparatus of claim 8, further including conductive spacers configured for providing electrical communication between the absorption layer and the interferometric subpixels.

10. The apparatus of claim 1, wherein the absorption layer is formed of desiccant material.

11. The apparatus of claim 1, further including a layer of desiccant material formed on the absorption layer.

12. The apparatus of claim 1, further comprising:
a display including the array of interferometric modulation subpixels;
a processor that is configured to communicate with the display, the processor being configured to process image data; and
a memory device that is configured to communicate with the processor.

13. The apparatus of claim 12, further comprising:
a driver circuit configured to send at least one signal to the display; and
a controller configured to send at least a portion of the image data to the driver circuit.

14. The apparatus of claim 12, further comprising:
an image source module configured to send the image data to the processor.

15. The apparatus of claim 14, wherein the image source module includes at least one of a receiver, transceiver, and transmitter.

16. The apparatus of claim 12, further comprising:
an input device configured to receive input data and to communicate the input data to the processor.

17. An apparatus, comprising:
a substantially transparent first substrate;
an array of interferometric modulation subpixels disposed on the substantially transparent substrate;
enclosing means for forming an enclosure for the array of subpixels, the enclosing means attached to the first substrate; and
light absorption means for absorbing light that enters the first substrate and passes between gaps in the interferometric modulation subpixels, the light absorption means being formed on the enclosing means.

18. The apparatus of claim 17, wherein the light absorption means includes electrically conductive means for providing electrical communication with the interferometric modulation subpixels.

19. A method, comprising:
forming an array of interferometric modulation subpixels on a substantially transparent first substrate, the subpixels including column electrodes and row electrodes, the column electrodes and row electrodes patterned to form gaps between adjacent column electrodes; and
attaching a second substrate to the first substrate to form an enclosure for the array of interferometric modulation subpixels, the second substrate having an absorption layer formed thereon, the absorption layer being configured to absorb light that enters the first substrate and passes between the column electrodes of the second layer.

20. The method of claim 19, wherein forming the array of interferometric modulation subpixels includes:
forming an optical stack into row electrodes on the first substrate, the optical stack including a first layer that is conductive and partially reflective;
forming a plurality of support structures; and
forming a second layer into conductive and reflective column electrodes on the support structures.

21. The method of claim 20, further comprising:
forming the absorption layer on the second substrate.

22. The method of claim 21, wherein forming the absorption layer on the second substrate involves a printing process.

23. The method of claim 21, wherein the process of forming the absorption layer on the second substrate is performed prior to attaching the second substrate.

24. The method of claim 21, wherein forming the absorption layer on the second substrate involves forming conductive spacers configured for providing electrical communication between the absorption layer and the first layer.

25. The method of claim 24, further comprising:
forming a routing area outside the array of subpixels, wherein forming the absorption layer on the second substrate involves forming conductive spacers configured for providing electrical communication between the absorption layer and the routing area.

26. The method of claim 21, wherein the absorption layer is formed of desiccant material.

27. The method of claim 21, further comprising:
forming a layer of desiccant material on the absorption layer.

28. The method of claim 20, wherein forming the optical stack on the first substrate involves forming black mask material only in support structure areas.

29. The method of claim 20, wherein forming the optical stack on the first substrate involves forming black mask material in support structure areas and in interconnecting row areas.
